(19) United States
(12) Patent Application Publication
(10) Pub. No.: US 2015/0292677 A1
(43) Pub. Date: Oct. 15, 2015

(54) METHOD OF MANUFACTURING A COMPRESSED GAS CYLINDER

(71) Applicant: FIVES MACHINING SYSTEMS, INC., Fond du Lac, WI (US)

(72) Inventors: Richard A. Curless, Cincinnati, OH (US); David S. Brookstein, Fort Washington, PA (US); Randall A. Kappesser, Cincinnati, OH (US); Daniel Allman, Hebron, KY (US)

(21) Appl. No.: 14/387,122

(22) PCT Filed: Mar. 13, 2013
(86) PCT No.: PCT/US2013/030725

§ 371 Date: Sep. 22, 2014

Related U.S. Application Data
(60) Provisional application No. 61/614,207, filed on Mar. 22, 2012.

(51) Int. Cl. F17C 1/04; B32B 37/14

(52) U.S. Cl. CPC F17C 1/04; B32B 37/142; B32B 37/144; B32B 2305/08; B32B 2307/736; B32B 2307/50; B32B 2313/04; B32B 2323/04; B32B 2367/00; B32B 2439/40

(57) ABSTRACT

A method of forming a reinforced pressure vessel includes the steps of providing a thin wall cylinder, wrapping the cylinder with at least one layer of prepreg reinforcing fiber, wrapping the cylinder with at least one layer of perforated shrink tape, applying heat to the shrink wrapped cylinder to squeeze the at least one prepreg fiber layer to force resin to weep through the perforated shrink tape and cure the resin, and allowing the resin to remain on the outer surface of the shrink tape to form a protective layer on the pressure vessel.

This application claims priority of U.S. provisional application Ser. No. 61/614,207 filed Mar. 22, 2012 and international application PCT/US2013/030725 filed Mar. 13, 2013.

### FIELD

A method of manufacturing a pressure vessel for containing a compressed gas is disclosed in which a thin wall cylinder is wrapped with resin impregnated reinforcing fiber and shrink wrap polymeric tape prior to being cured to eliminate voids in the cured composite and to form a protective layer on the vessel.

### BACKGROUND

Compressed natural gas (CNG) and pressurized hydrogen are finding increasing application as an alternative fuel for internal combustion engines. As a result, there is a need to have relatively light weight high strength pressure vessels to contain the pressurized gas. The mechanical requirements for such pressure vessels include a relatively high burst strength on the order of 10,000 psi.

There are four general categories of pressure vessels that are used to store compressed gas. Type 1 cylinders are all metal and are mechanically inefficient since circumferential stress loads in a pressurized gas cylinder are approximately double the axial stress loads. Type 2 cylinders comprise a metal liner with a resin impregnated continuous reinforcing fiber assembly that is hoop-wrapped only over the cylindrical body of the metal liner. All axial loads are borne by the metal liner and the hoop-loads are borne by a combination of the metal liner and the composite reinforcement. Type 3 cylinders comprise a metal liner with resin impregnated continuous fiber assembly fully wrapped over the end domes and hoop wrapped over the cylinder body. Type 4 cylinders comprise a non-metallic liner with a resin impregnated fiber assembly fully wrapped over the end domes and hoop wrapped over the cylinder body. For Type 2, Type 3 and Type 4 CNG tanks, the current standard adopted by industry and government requires that the composite overwrap be designed for high reliability under sustained loading and cyclic loading. This reliability is achieved by meeting or exceeding the composite reinforcement stress ratio values of 2.25× the service pressure. For typical CNG tanks with a service pressure of 3,600 psi, this is about 8,100 psi.

Filament winding is one of the most established composite manufacturing processes, and is the method of choice for producing CNG tanks. The first winding machines were developed in the late 1960's and were initially developed to produce composite rocket casings. During 1990's the production of composite pressure vessels with the filament winding technique was further developed. Over the last 30 years, filament winding machines have been equipped with modern CNC controllers, improved machine frames, automatic start and stop modules, and robotic systems to supply the gas impermeable liners to the filament winding machines. Although these developments have reduced the winding time, the labor demand of the process is still relatively high. The main reasons are the problems associated with the use of resin baths for fiber impregnation and the relatively low winding speeds associated with fiber impregnation that is coupled with filament winding. This problem has been overcome by the use of pre-impregnated fiber assemblies (i.e., pre-preg tows).

Two winding patterns are possible for compressed gas cylinders: hoop and axial (also referred to as isotensoid). Type 2 vessels are hoop-wrapped only. Types 3 and 4 vessels are generally a combination of hoop and axial (isotensoid) wrapping. Vessels can be filament wound in the same winding machine if it is equipped more than one winding head.

In addition to the use of reinforcing fibers, the manufacture of a pressure vessel requires a polymeric resin, such as a thermosetting epoxy for example, to bond the reinforcing fibers to each other and to the cylinder liner. The resin also plays an important function of transferring stresses from fiber to fiber.

There are various methods to apply the resin to the fibers. A resin transfer molding process can be used in which layers of dry un-impregnated fibers can be wrapped onto the cylinder which is then placed into a female mold. Uncured relatively viscous resin is then infused under pressure into the mold. Once infused, the resin is heated, and the resin thus completes its polymerization cycle and hardens. The resin transfer fiber reinforced cylinder is then removed from the mold. The primary limitations of this process are the relatively high cost of the molds and tooling, and the time it takes for the resin to cure or polymerize.

CNG tanks can also be fabricated using the wet-filament winding process. This is a process in which the fiber tow is passed through a resin bath to impregnate the tow and then wrapped around a mandrel prior to curing in an oven at elevated temperature. Wet winding has substantial resin waste that is inherent to the process, and is notorious for creating substantial volatile organic compounds during the manufacturing process. Wet wound cylinders can also have non-load bearing voids in the cured composite structure.

Another method for applying resin involves the use of pre-impregnated or “prepreg” fibers that have had partially cured resin applied to them prior to the wrapping process. Since the resin is partially cured, the resin is no longer in the liquid state, and the fibers can be wound onto the liner by automated equipment.

One way to overcome voids in the finished product is to apply pressure by means of a flexible sleeve to the outer surface of the fibers prior to the final resin cure. This is commonly done by using a “bagging process” whereby the pre-impregnated fiber covered cylinder is placed in a relatively flexible polymer bag and then placed in a heated autoclave. While this approach is mechanically feasible, the relatively high cost of autoclave equipment increases the cost of the finished product.

### SUMMARY OF THE DEVICE

A liner is wrapped with pre-impregnated fiber tow using a conventional filament winding process. The prepreg tow provides a more controlled resin content and less variation in the cured part than other processes, and provides a cleaner process than a wet process, with little or no emission of volatile gas compounds. The resin may contain a nano material that increases the strength of the resulting composite structure. A shrink wrap tape is wrapped over the reinforcing fibers, and heat is applied to the tape to apply a compressive force to the reinforcing fibers in order to preclude the formation of voids in the cured resin and to cure the resin itself. The tape can be perforated to allow resin to weep onto the outer surface of the shrink wrap tape, forming a protective layer on the finished product.

### BRIEF DESCRIPTION OF THE DRAWINGS

FIG. 1 is a side view of a cylinder prior to being wound with prepreg fiber.

FIG. 2 is a side view of the cylinder of FIG. 1 after being wound end to end with prepreg fiber.

FIG. 3 is a side view of the cylinder of FIG. 2 after being hoop wound with prepreg fiber.

FIG. 4 is a side view of the cylinder of FIG. 3 after being wound end to end with perforated shrink tape.

FIG. 5 is a side view of the cylinder of FIG. 4 after being hoop wound with perforated shrink tape.

FIG. 6 is a magnified view of section 6 designated on FIG. 5.

FIG. 7 is a side view of the cylinder of FIG. 5 in a heating and curing oven.

FIG. 8 is a side view of the cylinder of FIG. 5 after being removed from the heating and curing oven of FIG. 7.

FIG. 9 is a magnified view of section 9 designated on FIG. 8.

FIG. 10 is a perspective view, partly in section showing the layers of the cylinder of FIG. 8 after being removed from the heating and curing oven of FIG. 7.

FIG. 11 shows the steps in the method of manufacturing the cylinder of FIG. 8.

### DESCRIPTION OF THE PREFERRED EMBODIMENT

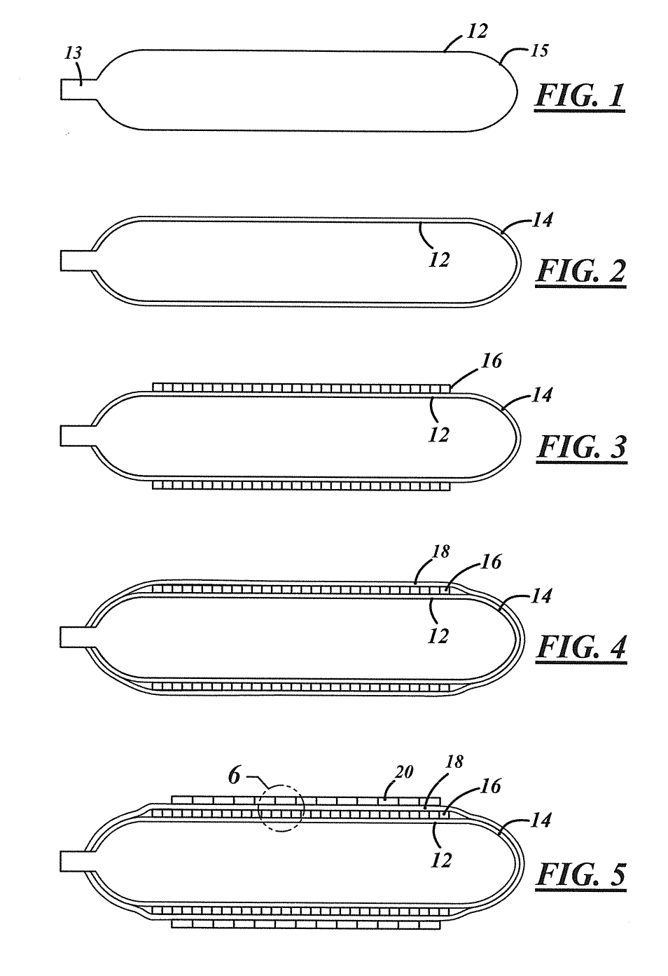

FIG. 1 is a side view of a cylinder liner 12 prior to being wound with reinforcing fiber. The cylinder 12 is shown with a connector neck 13 at one end and a domed termination 15 at the other end, but the cylinder may be formed with connector necks 13 at both ends if desired. The cylinder may comprise aluminum, steel, or any other metal that can be formed into a thin wall container. The cylinder may also comprise plastic or other similar non-metallic material.

FIG. 2 is a side view of the cylinder 12 after being wound longitudinally, end to end with prepreg fiber 14. The use of fiber 14 with resin coated onto the fiber, or prepreg fiber, eliminates the need for a costly resin transfer molding process that is required if the cylinder is wound with dry or un-impregnated fiber. To comply with US Department of Transportation requirements, if the cylinder 12 is metal, a galvanic corrosion protection layer is required between the metal and the outer reinforcing layers. For this purpose, a plastic layer or a glass filament and epoxy layer may be applied to the outer surface of the cylinder 12 prior to the application of a fiber reinforcing layer 14.

A wide variety of reinforcement materials can be used for the fiber 14, including, but not limited to, carbon fiber, aramid fiber, high strength polyethylene fiber, and fiberglass fiber. In one embodiment, carbon fibers were employed. The reinforcement materials may take the form of tow or slit tape. The tow may be round or oval or flattened in cross-section.

The pre-preg materials coated onto the fiber 14 may comprise either conventional thermoset resins, or newly developed nano-material infused thermoset resin. Nano-materials resin has improved tensile strength permitting the use of less carbon fiber based material than that required with conventional prepregs. The reduced carbon fiber reduces the cost of the wrap, and enables the wrap to be completed in less time.

FIG. 3 is a side view of the cylinder 12 after being hoop wound with prepreg fiber 16. The hoop winding 16 reinforces the cylinder against hoop stresses which in a cylinder are generally twice the axial stresses when the cylinder is pressurized. After the fiber windings 14 and 16 have been applied, the wound uncured tank is overwrapped with a combination of isotensoid and hoop oriented shrink tape as described below.

FIG. 4 is a side view of the cylinder 12 after being wound end-to-end with a shrink tape layer 18. The shrink tape layer 18 completely covers the fiber layers 14 and 16. The shrink tape 18 has a free shrinkage of about 20% at the towpreg cure temperature of 300° F. The shrink tape 18 is not itself adhesive and as a result, a pressure sensitive layer may first be applied to the outer surface of the fiber wrap 16 to prevent movement of the tape 18 during cure. In other embodiments, the shrink tape may have adhesive qualities, in which case, a separate pressure sensitive layer does not have to be applied to the outer surface of the fiber wrap 16. The use of the shrink tape 18 eliminates the use of expensive female molds and autoclaves in the manufacturing process.

FIG. 5 is a side view of the cylinder 12 after being hoop wound with a shrink tape layer 20. The hoop wrap layer 20 is applied over the longitudinal wrap layer 18 of shrink tape 18.

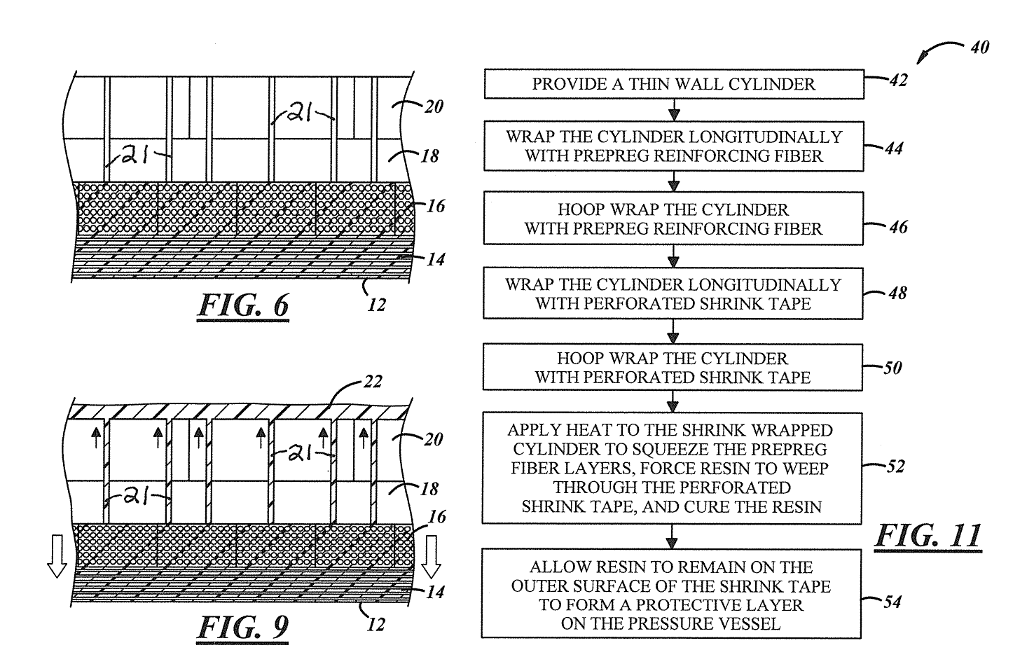

FIG. 6 is a magnified view of section 6 designated on FIG. 5. FIG. 6 shows the isotensoid layer 14 and the hoop layer 16 of prepreg fiber applied to the outer surface of the tank 12. An axial layer 18 and a hoop layer 20 of shrink tape are wrapped over the prepreg fiber layer 16. The shrink tape used in the layers 18 and 20 may contain perforations 21.

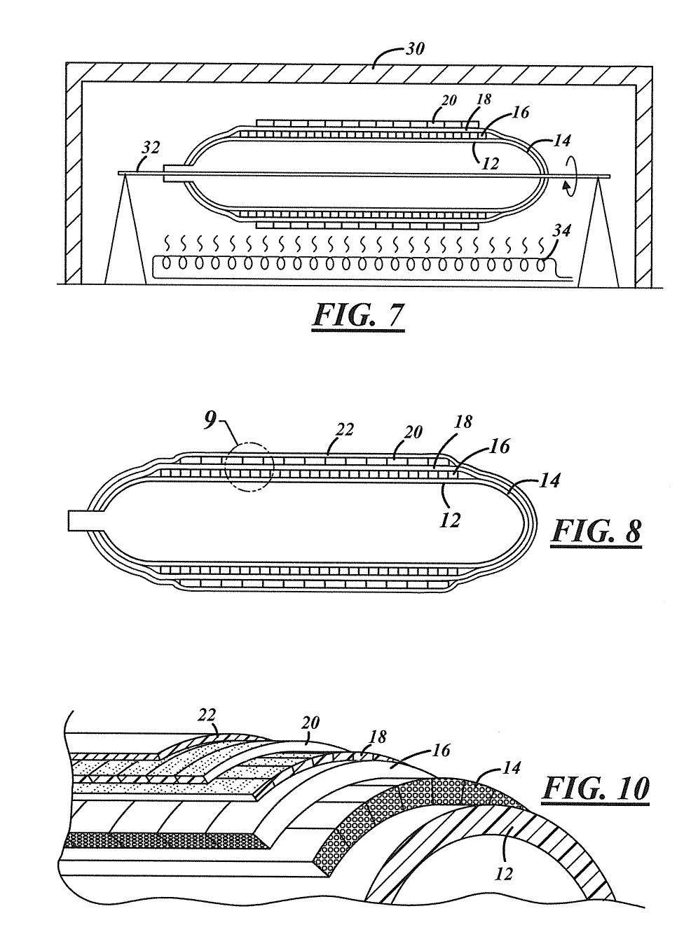

FIG. 7 is a side view of the wrapped cylinder 12 in a heating and curing oven 30. The cylinder is supported on an elongated mandrel 32 in the oven 30, and heat is supplied by means of a heating element 34. The mandrel may be rotated to evenly expose the entire outer surface of the cylinder 12 to the heating element 34. More than one heating element 34 may be used in the heating oven 30. The interior of the heating oven 30 may be maintained at atmospheric pressure during the curing cycle. Application of heat from a heating element 34 causes the tape layers 18 and 20 to shrink and apply pressure to the fiber layers 14 and 16, eliminating any voids in the fiber layers layer without the need to use elevated pressure.

By heating the shrink wrapped cylinder 12 in an oven at atmospheric pressure, the shrink tape layers 18 and 20 shrink, and provide substantial compressive forces to consolidate the filament wound pressure vessel and eliminate voids in the final product. The heat shrink tape may be left on after curing to provide a protective covering for the tank. Suitable shrink tape for this purpose is sold under the name Dunstone Hi-Shrink Tape. The tape may be perforated or un-perforated.

It has been determined that by wrapping high shrink polyester tape over the finished wound cylinder, the cylinder can be heated to the relatively low temperature of 300° F. using a fast cure time of approximately one hour to obtain an essentially void free cured composite. The polyester tape is known to have excellent resistance to most substances. It is resistant to acids, oxidizers such as hydrogen peroxide and most solvents. Polyester also has excellent resistance to hydrocarbon fuels, oils and lubricants. Accordingly, the protective polyester layers provided by the tape layers 18 and 20 will add to the durability and environmental resistance of the resulting compressed gas tanks.

The heat shrink tape used in the layers 18 and 20 may also be perforated. The perforations allow excess resin to weep through the tape and after curing provide a protective layer of resin over the tape, thus obviating the need to apply a protective coating on the final composite cylinder through by means of a separate process step. A suitable perforated shrink tape is produced by Dunstone Company, Inc and is sold under the name Perforated Hi-Shrink Tape 220. The tape will begin to shrink at about 65° C., and has been used in applications up to 180° C. If unrestrained, the tape will shrink 20% after 15 minutes at 150° C. Layers of shrink tape are wound onto the outer surface of the fiber wrapped tank to form a longitudinal wrap layer 18 as shown in FIG. 4 and to form a hoop wrap layer 20 as shown in FIG. 5. The shrink tape winding may be performed by an automated winding process.

FIGS. 8 and 10 are a side view and a perspective sectional view, respectively, of the wrapped cylinder 12 after being removed from the heating and curing oven of FIG. 7. After curing, the shrink tape layers 18 and 20 remain on the resulting reinforced pressure vessel 12, and a cured resin layer 22 is formed on the outer surface of the shrink tape layers 18 and 20 as a result of the resin from the prepreg tape layers 14 and 16 being compressed by the shrinkage of the tape layers 18 and 20.

FIG. 9 is a magnified view of section 9 designated on FIG. 8. FIG. 9 shows the compressing of the prepreg fiber layers 14 and 16 by the shrink tape layers 18 and 20, and the propagation of the resin from the layers 14 and 16 through the perforations 21 in the shrink tape layers 18 and 20, respectively, to form the outer resin layer 22.

FIG. 11 shows a sequence of steps in the method 40 of forming a reinforced pressure vessel according the description given above. The method 40 includes a first step 42 of providing a thin wall cylinder, a second step 44 of wrapping the cylinder longitudinally with a prepreg reinforcing fiber, and a third step 46 of hoop wrapping the cylinder with prepreg reinforcing fiber. The method 40 continues with a fourth step 48 of wrapping the cylinder longitudinally with perforated shrink tape, a fifth step 50 of hoop wrapping the cylinder with perforated shrink tape, and a sixth step 52 of applying heat to the shrink wrapped cylinder to squeeze the prepreg fiber layers to force resin to weep through the perforated shrink tape, and to cure the resin. The method 40 concludes with the step 54 of allowing the resin to remain on the outer surface of the shrink tape to form a protective layer on the pressure vessel.

The high pressure composite storage tank disclosed herein is manufactured using a new pressure application system that is coupled with a conventional filament winding system. The manufacturing system is capable of being highly automated, and is able to deposit prepreg carbon fiber on either Type 3 or Type 4 liners in an expedited manner. Further, the proposed manufacturing system enables “moldless” curing and a relatively fast resin cure cycle. The tanks may be manufactured using novel nano-material carbon-fiber based prepregs that offer improved mechanical properties. The use of these materials can reduce weight and manufacturing time by lessening the number of winding layers that are required to achieve the desired strength, leading to cost reductions.

Having thus described the device, various modifications and alterations will occur to those skilled in the art, which modifications and alterations will be within the scope of the device as defined by the appended claims.

We claim:

1. A method of forming a reinforced pressure vessel, the method comprising the steps of:
providing a thin wall cylinder;
wrapping the cylinder with at least one layer of prepreg reinforcing fiber;
wrapping the cylinder with at least one layer of shrink tape;
applying heat to the shrink tape wrapped cylinder to squeeze the at least one prepreg fiber layer to force resin to weep through the shrink tape, and to cure the resin; and,
allowing the resin to remain on the outer surface of the shrink tape to form a protective layer on the pressure vessel.

2. The method of claim 1 further comprising the step of:
wrapping the cylinder with at least two layers of prepreg reinforcing fiber.

3. The method of claim 2 further comprising the steps of:
wrapping one of the prepreg reinforcing fiber layers in an axial or longitudinal direction on the cylinder; and,
wrapping another of the prepreg reinforcing fiber layers in a hoop direction on the cylinder.

4. The method of claim 1 further comprising the step of:
wrapping the cylinder with at least two layers of shrink tape.

5. The method of claim 4 further comprising the steps of:
wrapping one of the shrink tape layers in an axial or longitudinal direction on the cylinder; and,
wrapping another of the shrink tape layers in a hoop direction on the cylinder.

6. The method of claim 5 further comprising the steps of:
providing perforations in the shrink tape, whereby at least a portion of the resin from the prepreg reinforcing fibers weeps through the perforations in response to the application of heat to the shrink tape wrapped cylinder.

7. The method of claim 2 further comprising the steps of:
wrapping the cylinder with at least two layers of shrink tape.

8. The method of claim 7 further comprising the steps of:
wrapping one of the shrink tape layers in an axial or longitudinal direction on the cylinder; and,
wrapping another of the shrink tape layers in a hoop direction on the cylinder.

9. The method of claim 8 further comprising the steps of:
providing perforations in the shrink tape, whereby at least a portion of the resin from the prepreg reinforcing fibers weeps through the perforations in response to the application of heat to the shrink tape wrapped cylinder.

10. The method of claim 8 further comprising the steps of:
wrapping one of the prepreg reinforcing fiber layers in an axial or longitudinal direction on the cylinder; and,
wrapping another of the prepreg reinforcing fiber layers in a hoop direction on the cylinder.

11. A reinforced pressure vessel, the vessel comprising:
a thin wall cylinder liner;
at least one layer of prepreg reinforcing fiber wrapped onto the cylinder liner;
at least one layer of shrink tape wrapped onto the cylinder;
a layer of resin on the outer surface of the shrink tape to form a protective layer on the outside surface of the pressure vessel.

12. The reinforced pressure vessel of claim 11 further comprising:
a first layer of prepreg reinforcing fiber oriented in an axial or longitudinal direction on the cylinder liner; and,
a second layer of prepreg reinforcing fiber oriented in the hoop direction on the cylinder liner.

13. The reinforced pressure vessel of claim 12 further comprising:
at least two layers of shrink tape wrapped onto the cylinder liner;
the first layer of shrink tape oriented in an axial or longitudinal direction on the cylinder liner; and,
the second layer of shrink tape oriented in the hoop direction on the cylinder liner.

14. The reinforced pressure vessel of claim 13 further comprising:
perforations formed in the shrink tape, whereby resin from the prepreg fibers weeps through the perforations when the shrink tape is heated to form the protective layer on the pressure vessel.

15. The reinforced pressure vessel of claim 11 wherein the prepreg reinforcing fiber is selected from the group consisting of carbon fiber, aramid fiber, high strength polyethylene fiber, fiberglass fiber, or combinations thereof.

16. The reinforced pressure vessel of claim 11 wherein the reinforcing fiber is selected from the group consisting of individual fiber, tow, slit tape, or combinations thereof.

17. The reinforced pressure vessel of claim 11 further comprising:
a polyester tape comprising the shrink tape, wherein the shrink tape shrinks in response to the application to heat to eliminate voids in the prepreg reinforcing fiber layers without the need to use elevated pressure.

18. The reinforced pressure vessel of claim 11 further comprising:
a thermoset resin comprising the prepreg material that is coated onto the reinforcing fiber.

19. The reinforced pressure vessel of claim 11 further comprising:
a nano-materials resin comprising the prepreg material that is coated onto the reinforcing fiber.
